(19) United States
(12) Patent Application Publication
(10) Pub. No.: US 2010/0158379 A1
(43) Pub. Date: Jun. 24, 2010

(54) IMAGE BACKGROUND REMOVAL

(75) Inventors: Larry Tucker Hatfield, Bothell, WA (US); Scott Harrison Douglas, Seattle, WA (US); Nicholas William Rohring, Bothell, WA (US); Matthew Kotler, Sammamish, WA (US); Mobeen Fikree, Mississauga (CA)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/337,654

(22) Filed: Dec. 18, 2008

(51) Int. Cl. G06K 9/46

(52) U.S. Cl. 382/190

(57) ABSTRACT

A request is received to enter a background removal mode. A marquee is displayed for specifying a portion of an image to be provided to a foreground extraction engine (“FEA”). The portion of the image defined by the marquee is provided to the FEA. The FEA identifies the foreground and returns it to the application program. The image is displayed with the foreground distinguished from the background. If the marquee is re-sized or re-positioned, the portion of the image defined by the marquee is provided to the FEA. A line segment may be drawn over the background to define a portion of the image for inclusion in the foreground. A line segment may also be drawn over the foreground to define a portion of the image for inclusion in the background. Upon exit of the background removal mode, only the foreground of the image is displayed.

### BACKGROUND

Office document creation application programs, such as word processing, spreadsheet, and presentation applications, typically support functionality for inserting images into documents. For instance, a user may create a presentation document that includes one or more slides. The user may then insert an image onto one of the slides.

When inserting an image into a document, it is often desirable to isolate a foreground portion of the image from a background portion. Through this process the background portion of the image can be removed leaving only the foreground portion of the image visible. For instance, an image of a person might have distracting subject matter shown behind the person in the background. By removing the background of the image the distracting subject matter can be removed, thereby highlighting the person.

Office document creation application programs typically do not provide functionality for removing the background from an image. As a result, it is commonly necessary to utilize a dedicated image editing application program in order to remove an image background. Once the background of the image has been removed using an image editing application program, the modified image can be imported into the document being created.

Current tools for background removal are primarily designed for high-end image editing application programs. As a result, these tools often provide user interfaces that are complex and cumbersome. Consequently, these tools are of limited value to information workers creating documents utilizing office document creation applications like word processing, spreadsheet, and presentation application programs.

It is with respect to these considerations and others that the disclosure made herein is presented.

### SUMMARY

Technologies are described herein for image background removal. In particular, through an implementation of the concepts and technologies presented herein, the background of an image in a document can be quickly and easily isolated from the foreground of the image and removed. Moreover, the image background can be removed while the image is in the context of the document and without the need for a dedicated image editing application program.

According to one embodiment presented herein, an application program provides a background removal mode of operation in which the background of an image can be removed from the image. In this mode of operation, the application program provides a user interface for removing the background of the image. The user interface provides a mechanism for selecting a portion of the image upon which a foreground extraction engine operates to identify the foreground of the image, for selecting portions of the background of the image to be included in the foreground, for selecting portions of the foreground of the image to be included in the background, and for undoing such selections.

In one embodiment, an image is inserted into a document and selected. A request is then received to enter the background removal mode of operation. In response to such a request, a marquee is displayed for specifying a portion of the image to be provided to the foreground extraction engine. In one implementation, for instance, the marquee comprises a rectangle initially sized and located within the image. User interface controls are also provided for re-sizing and re-positioning the marquee. It should be appreciated that the marquee may comprise any shape.

Upon entering the background removal mode of operation, the portion of the image defined by the marquee is provided to the foreground extraction engine. The foreground extraction engine receives the image portion, identifies the foreground, and returns the foreground to the application program. The application program then displays the image such that the foreground is distinguished from the background of the image. For instance, in one embodiment the background is displayed as partially transparent. The marquee is then displayed over the image.

If the marquee is re-sized or re-positioned, the portion of the image defined by the new size and/or position of the marquee is provided to the foreground extraction engine. The foreground extraction engine receives the image portion, identifies the foreground, and returns the foreground to the application program. The application program then displays the image such that the foreground is distinguished from the background of the image.

In one embodiment, a user interface is also provided through which a user can specify that certain portions of the image that are in the background be included in the foreground. For instance, in one implementation, a user can draw a line segment over a background portion to define the portion of the image to be included in the foreground. The portion of the image corresponding to the line segment is then included in the foreground by the foreground extraction engine. If the line segment is outside the bounds of the marquee, the size of the marquee will be increased so that it includes the line segment.

A user interface is also provided in one embodiment through which a user can specify that certain portions of the image that are in the foreground be included in the background. For instance, a user can draw a line segment over a foreground portion in one embodiment to define the portion of the image to be included in the background. The portion of the image corresponding to the line segment is then included in the background by the foreground extraction engine.

When a request is received to exit the background removal mode of operation, the display of the marquee is removed. Additionally, the display of the background portion of the image is also removed, thereby showing only the foreground of the image. A user may re-enter the background removal mode of operation to modify the size and position of the marquee, to add portions of the image to the foreground, or to remove portions of the image from the foreground.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of an illustrative operating environment and several software components provided by the embodiments presented herein;

FIGS. 2-9 are screen diagrams showing aspects of various user interfaces presented herein for image background removal;

FIGS. 10A-10B are flow diagrams showing one illustrative routine provided herein for image background removal; and

FIG. 11 is a computer architecture diagram showing an illustrative computer hardware and software architecture for a computing system capable of implementing aspects of the embodiments presented herein.

### DETAILED DESCRIPTION

The following detailed description is directed to technologies for image background removal. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of various technologies for image background removal will be described.

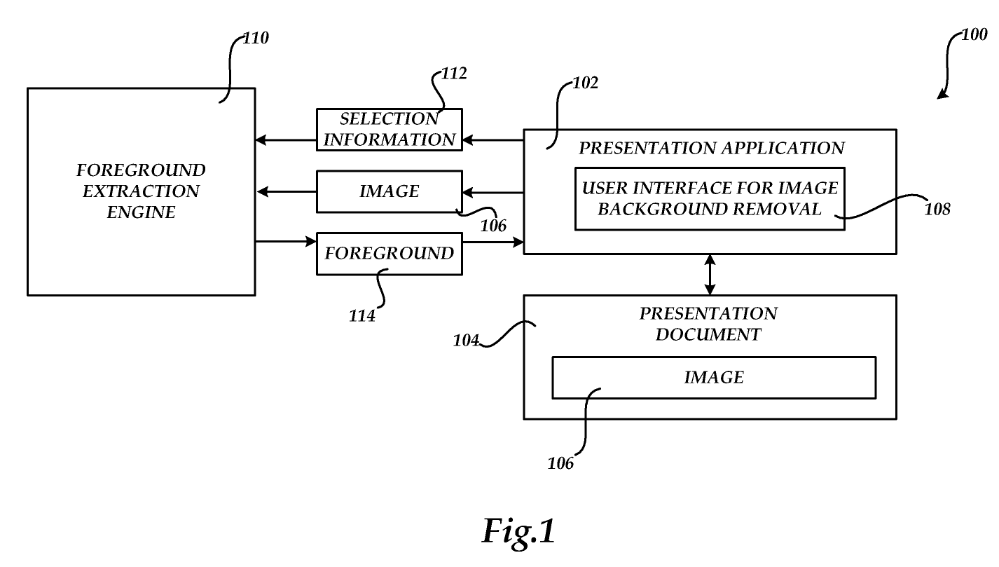

Turning now to FIG. 1, details will be provided regarding an illustrative operating environment and several software components provided by the embodiments presented herein. In particular, FIG. 1 shows a system 100 that forms an operating environment for one implementation described herein. As shown in FIG. 1, the system 100 includes a presentation application 102 configured to create a presentation document 104. For instance, in one implementation, the presentation application 102 may comprise the POWERPOINT presentation application from MICROSOFT CORPORATION. It should be appreciated that while the embodiments presented herein are described in the context of a presentation application 102, the embodiments presented herein may be utilized with any type of application program configured for creating a document that may include an image therein. For instance, the embodiments presented herein may be utilized with word processing application programs, spreadsheet application programs, page layout and design programs, and others. The embodiment presented herein may also be utilized with stand-alone or web-based image editing application programs.

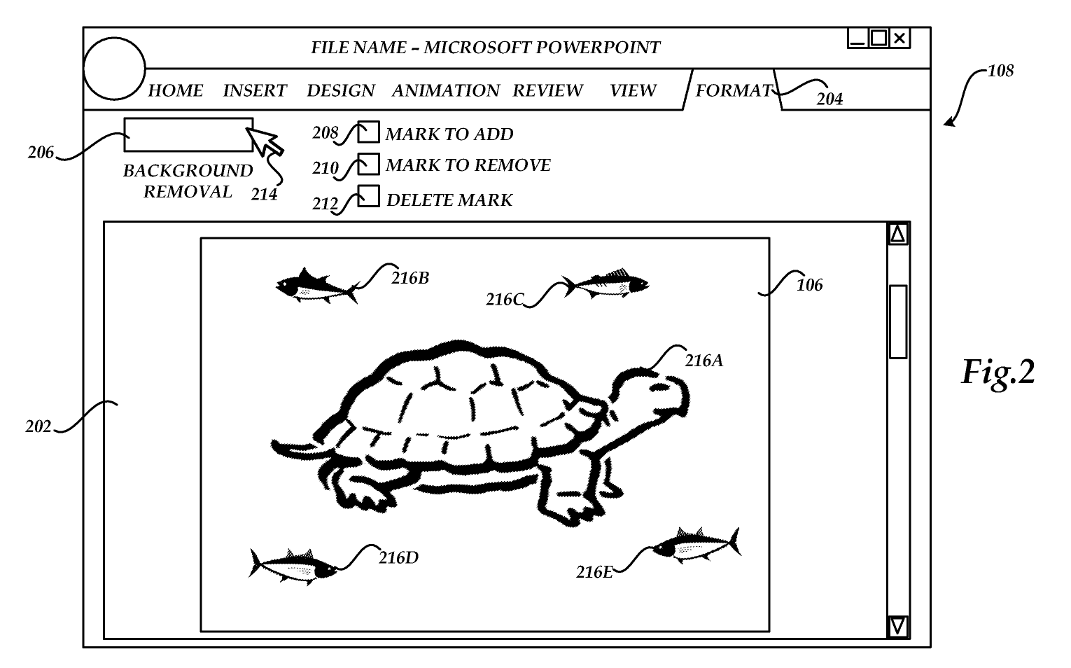

As illustrated in FIG. 1, the presentation application 102 is configured in one embodiment to allow a user to insert an image 106 into the presentation document 104. Through output generated by the presentation application 102, the image 106 may be displayed on a display screen of a computing system. In one implementation, the image 106 includes a foreground portion and a background portion. In order to remove the background portion from the image 106, the presentation application 102 provides a user interface 108 for image background removal in one embodiment presented herein. Details regarding the user interface 108 will be provided below with respect to FIGS. 2-9.

As will be discussed in greater detail below, in order to utilize the user interface 108 for image background removal, a user selects the image 106 in the presentation document 104. The user then requests through an appropriate user interface control to enter a background removal mode of operation. The background removal mode of operation is provided by the presentation application 102 and allows a user to specify a portion of the image 106 to be operated upon by a foreground extraction engine 110, to specify that portions of the foreground of the image 106 be included in the background, and to specify that portions of the image 106 in the background be included in the foreground. Additional details regarding the configuration and operation of the user interface 108 will be provided below with respect to FIGS. 2-9.

In one implementation, the user interface 108 includes a marquee through which a user can specify the portion of the image 106 to be provided to the foreground extraction engine 110. In one embodiment, for instance, the marquee comprises a rectangle. It should be appreciated that, however, that the marquee may take any shape, including but not limited to, circles, ovals, and other geometric shapes. A user may also be permitted to specify the shape utilized for the marquee.

Once the marquee has been utilized to select a portion of the image 106 to be provided to the foreground extraction engine 110, the presentation application 102 provides selection information 112 to the foreground extraction engine 110. The selection information 112 identifies the portion of the image 106 contained within the marquee. The presentation application also provides a copy of the image 106 to the foreground extraction engine 110. Alternately, the presentation application 102 may provide a pointer to the image 106 to the foreground extraction 110 so that a copy of the image 106 does not have to be made.

In response to receiving the selection information 112 and the image 106, the foreground extraction engine 110 executes an algorithm to identify the foreground portion of the image 106. When this process has completed, the foreground extraction engine 110 returns the foreground 114 to the presentation application 102. It should be appreciated that various algorithms exist for identifying a foreground 114 of an image 106. For instance, the “grabcut” interactive foreground extraction algorithm may be utilized to separate the foreground 114 from the remainder of the image 106. Details regarding the “grabcut” algorithm can be found in U.S. Pat. No. 7,430,339 entitled “Border Matting By Dynamic Programming”, which is assigned to the assignee of the instant patent application and expressly incorporated herein by reference in its entirety.

When the presentation document 104 receives the foreground 114 from the foreground extraction engine 110, the presentation document 104 is configured to display the image 106 in a manner that distinguishes the foreground 114 from the remainder of the image 106. For instance, in one embodiment, the presentation document 104 may display the background of the image 106 using partial transparency, shading, colorization, or another visual effect that allows a user to visually distinguish the foreground 114 from the remainder of the image 106.

As will also be described in greater detail below, the user interface 108 provides a mechanism through which a user can add portions of the image 106 in the background to the foreground 114. A user interface mechanism is also provided by which a user may specify that portions of the image 106 in the foreground 114 be moved to the background. A user interface mechanism is also provided to undo these modifications.

Once a user is satisfied with the removal of the background portion of the image 106, the user may request to exit the background removal mode of operation. In response to such a request, the presentation application 102 is configured to transform the image 106 such that only the foreground 114 is displayed to the user. For instance, the portion of the image 106 not identified within the foreground 114 may be displayed with complete transparency, thereby rendering this portion of the image 106 non-visible. According to embodiments, a user may reenter the background removal mode at any time to modify the portions of the image 106 included in the foreground 114. Additional details regarding the user interface 108 will be provided below with respect to FIGS. 2-9.

Referring now to FIG. 2, one illustrative user interface 108 for image background removal provided by the presentation application 102 in one embodiment will be described. As shown in FIG. 2, the presentation application 102 provides a canvas 202 upon which an image 106 may be placed. In the illustrative image 106 shown in FIG. 2, a number of objects 216A-216E are shown. In this example, the object 216A is in the foreground while the objects 216B-216E are within the background. It should be appreciated that the image 106 illustrated in FIG. 2 is merely illustrative and that any type of image may be utilized with the embodiments presented herein. As will be described in greater detail below, the user interface 108 provides a mechanism by which a user can remove the background of the image 106 to thereby show only the foreground. In particular, with respect to the illustrative image 106 shown in FIG. 2, the objects 216B-216E would be removed from the image 106 thereby leaving only the object 216A in view.

As shown in FIG. 2, a selectable user interface control 204 may be selected to display a number of additional user interface controls relating to the removal of the background of an image. In particular, a user interface control 206 is provided that may be selected to enter a background removal mode of operation provided by the presentation application 102. As will be described in greater detail below, the user interface control 206 may also be selected while in the background removal mode of operation to exit the background removal mode of operation. Any suitable user input mechanism may be utilized to select the user interface control 206 and the other user interface controls described herein, such as the use of a mouse user input device to make input using the mouse cursor 214.

As illustrated in FIG. 2, the user interface 108 also includes the selectable user interface controls 208, 210 and 212 for modifying the portions of the image 106 that are included in the foreground 114. As will be discussed in greater detail below, the user interface control 208 may be selected in order to add portions of the image 106 that have been included in the background to the foreground of the image 106. The user interface control 210 may be selected in order to remove portions of the foreground of the image 106 and have these portions included in the background of the image 106. The user interface control 212 may be selected in order to undo an addition to the foreground of the image 106 or a removal of a portion of the image 106 from the foreground. It should be appreciated that while the user interface controls 206, 208, 210, and 212 have been illustrated in FIG. 2 as being selectable user interface buttons, any appropriate user interface control may be utilized in order to allow a user to enter the background removal mode of operation and to specify portions of the image 106 to be included within or excluded from the foreground.

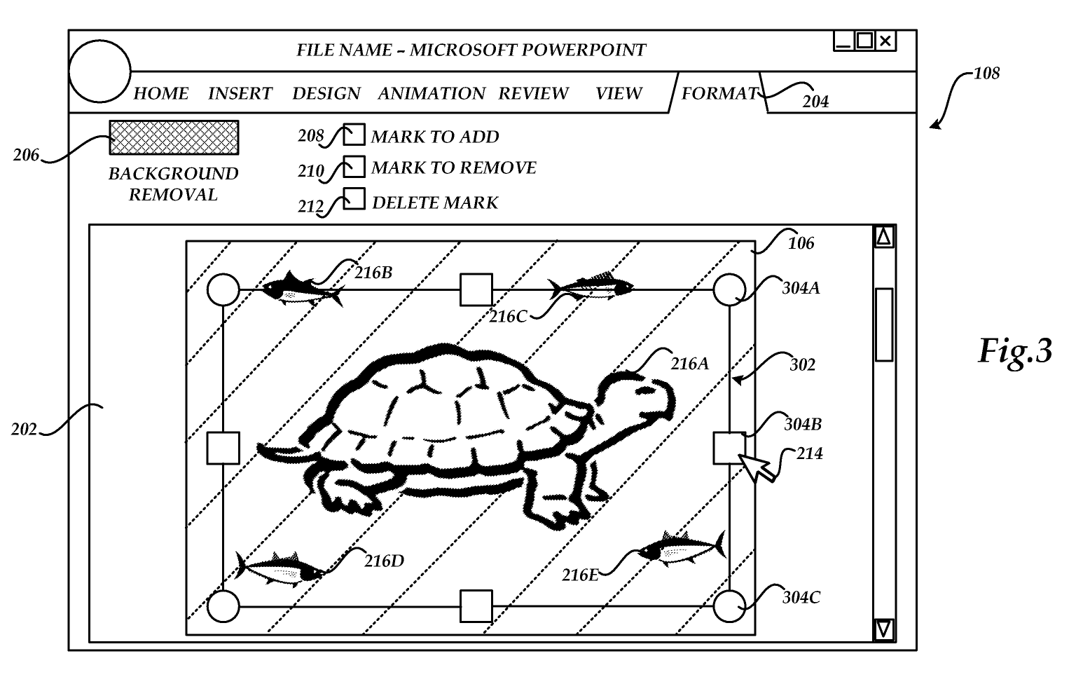

In the illustrative user interface 108 shown in FIG. 2, the cursor 214 has been utilized to select the image 106. The cursor 214 has then been utilized to select the user interface control 206 for entering the background removal mode of operation provided by the presentation application 102. In response to the selection of the user interface control 206, the user interface 108 shown in FIG. 3 and described below is displayed by the presentation application 102.

Referring now to FIG. 3, additional details regarding the background removal mode of operation provided by the presentation application 102 will be described. As shown in FIG. 3, the user interface control 206 has been selected to initiate the background removal mode of operation. In one embodiment, the user interface control 206 has been modified to change its visible appearance to indicate that the background removal mode of operation is active. Other types of visual indicators may be provided by the presentation application 102 to indicate that the background removal mode of operation is active.

In response to entering the background removal mode of operation, a marquee 302 has been displayed in conjunction with the image 106. In the embodiment shown in FIG. 3, the marquee 302 comprises a rectangle including a multitude of handles 304A-304C that may be selected using the cursor 214 to modify the size of the marquee 302. As discussed above, although the marquee 302 is illustrated herein as being a rectangle, the marquee 302 may take the form of other shapes. It should also be appreciated that the cursor 214 may be utilized to “grab” the marquee to reposition the marquee with respect to the image 106. In an alternate embodiment, the handles 304A-304C may be utilized to reshape the marquee 302. A user may also be provided a user interface control for adding additional handles. In this way, the marquee 302 could be utilized to identify a more exact outline within the image 106 to be selected.

In one implementation, the marquee 302 is initially located at a position inset from the four sides of the image 106. By insetting the position of the marquee 302 from the four sides of the image 106, strong lines such as the horizon that cross the entire image 106 may be excluded from the portion of the image 106 upon which the foreground extraction engine 110 operates. In this manner, the effectiveness of the foreground extraction engine 110 can be improved. It should be appreciated that other initial sizes and positions of the marquee 302 may be utilized. For instance, in another embodiment, the marquee 302 may be positioned and sized approximately one third of the way into the image 106. This positioning takes into account the common framing of subject matter by photographers utilizing the “rule of thirds.”

Once the initial size and position of the marquee 302 have been determined, the portion of the image 106 within the marquee 302 is provided to the foreground extraction engine 110 in the manner described above. In response thereto, the foreground extraction engine 110 identifies the foreground 114 of the image 106 and returns this information to the presentation application 102.

In response to receiving the foreground 114 from the foreground extraction engine 110, the presentation application 102 displays the image 106 in a manner that distinguishes the foreground 114 from the remainder of the image 106. For instance, in one implementation, the presentation application 102 displays the background of the image 106 using partial transparency or another effect to visually distinguish the foreground 114 of the image 106 from the background. In the example shown in FIG. 3, diagonal dotted lines are utilized to illustrate this effect. In particular, in the example shown in FIG. 3, the object 216A has been identified by the foreground extraction engine 110 as being in the foreground. Accordingly, no effects have been applied to the object 216A. The remainder of the image 106, including the objects 216B-216E, has been identified by the foreground extraction engine 110 as being in the background of the image 106. Accordingly, an effect has been applied to the remainder of the image 106 to visually distinguish it from the object 216A.

As discussed briefly above, a user may utilize the cursor 214 or another user input device to change the position and the size of the marquee 302. In response to such a change, the presentation application 102 again transmits the portion of the image 106 within the bounds of the marquee 302 to the foreground extraction engine 110. In response thereto, the foreground extraction engine 110 repeats the process for identifying the foreground 114 and returns the results to the presentation application 102. The presentation application 102 then displays the foreground 114 of the image 106 in a manner to distinguish it from the remainder of the image 106. In this way, a user can utilize the marquee 302 to fine tune the foreground identification process performed by the foreground extraction engine 110.

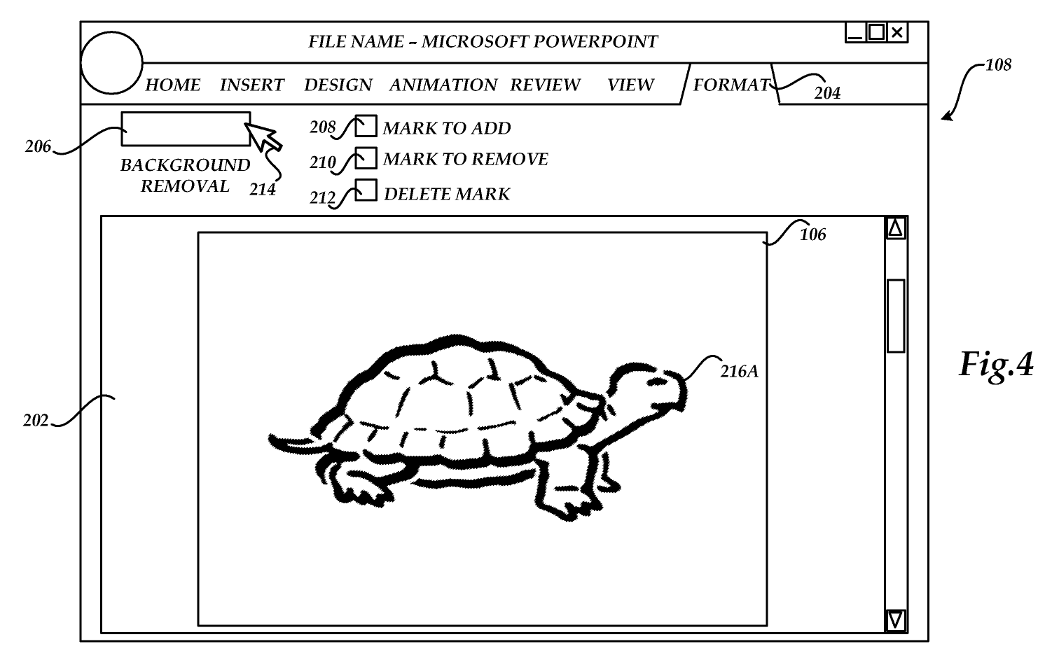

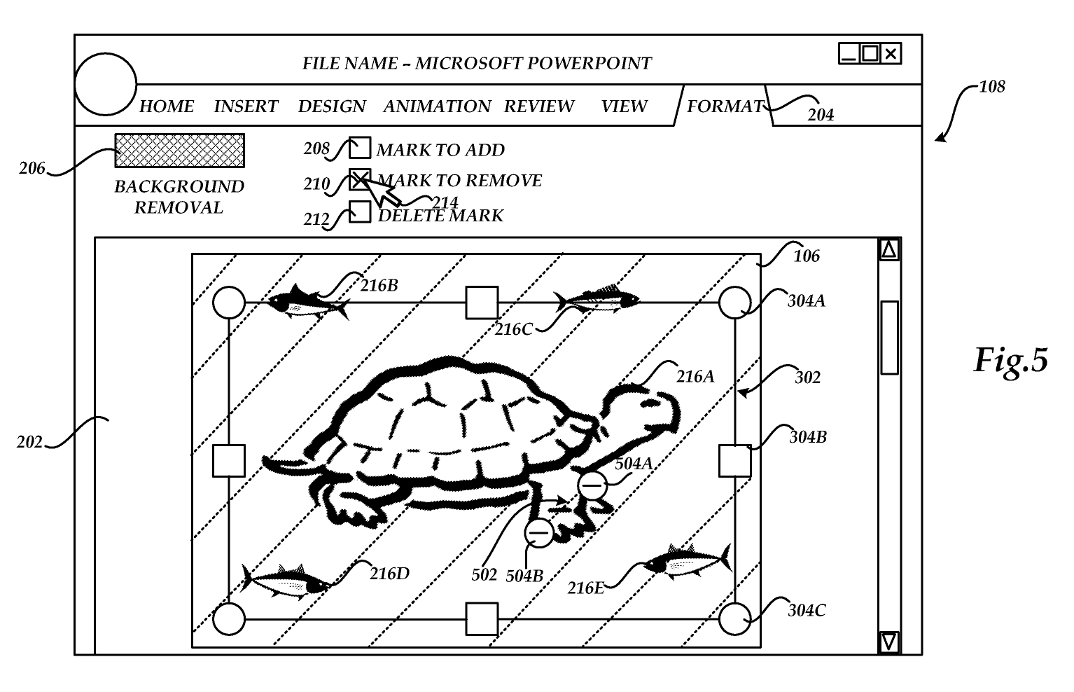

If the cursor 214 is utilized to select the user interface control 206, the presentation application 102 exits the background removal mode of operation. When the presentation application 102 exits the background removal mode of operation, the image 106 is transformed such that only the foreground 114 of the image 106 is displayed. FIG. 4 shows the user interface 108 after the cursor 214 has been utilized to select the user interface control 206 and exit the background removal mode of operation. In particular, only the object 216A is displayed in the illustrative image 106. As discussed briefly above, the user interface controls 208, 210 and 212 may be selected in order to add portions of the background of the image 106 to the foreground 114 and to add portions to the foreground 114 to the background of the image 106. FIGS. 5-9, described below, illustrate these processes.

In the example user interface 108 shown in FIG. 5, the cursor 214 has been utilized to select the user interface control 210. In response thereto, the presentation application 102 provides a user interface through which a user can specify a portion of the foreground 114 of the image 106 to be included in the background. For instance, in one implementation, a user is permitted to utilize the mouse cursor 214 to draw a line segment 502 over a portion of the image 106 to be removed from the foreground 114. In the example shown in FIG. 5, the line segment 502 is terminated by the indicators 504A-504B, which provide a visual indication that the line segment 502 will cause the corresponding portion of the image 106 to be removed from the foreground 114 of the image 106. It should be appreciated that because the foreground extraction engine 110 operates heuristically, the line segment 502 need not be drawn over the entire portion of the image 106 to be removed from the foreground 114.

In response to a user drawing the line segment 502, thereby identifying a portion of the image 106 to be removed from the foreground 114, the presentation application 102 provides data to the foreground extraction engine 110 identifying the portions of the image 106 corresponding to the line segment 502 that are to be removed from the foreground 114. In response thereto, the foreground extraction engine 110 removes the corresponding portions of the image from the foreground and moves these portions of the image 106 to the background.

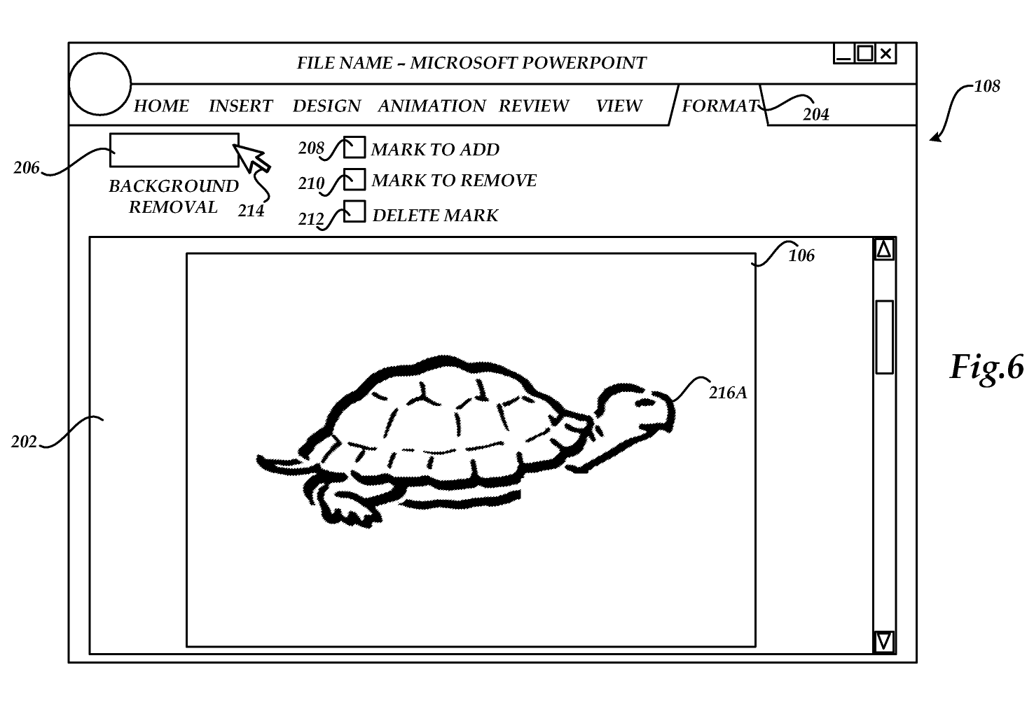

If, in the example shown in the FIG. 5, a user draws the line segment 502 over a portion of the object 216A, the corresponding portion of the object 216A will no longer be included in the foreground 114. For instance, if the cursor 214 is utilized to select the user interface control 206 to exit the background removal mode of operation, the user interface 108 shown in FIG. 6 will be displayed. As illustrated in FIG. 6, the portion of the object 216A corresponding to the line segment 502 has been removed from the foreground and is no longer displayed by the presentation application 102.

It should be appreciated that any number of line segments may be drawn on the image 106 in the manner described above to thereby remove corresponding portions of the image 106 from the foreground 114. It should also be appreciated that the use of a line segment is merely illustrative and that other types of shapes may be drawn on the image 106 to specify portions thereof to be removed from the foreground 114. For instance, according to embodiments, circles may be drawn on the image 106 or other shapes to thereby indicate that the corresponding portions are to be removed from the foreground 114.

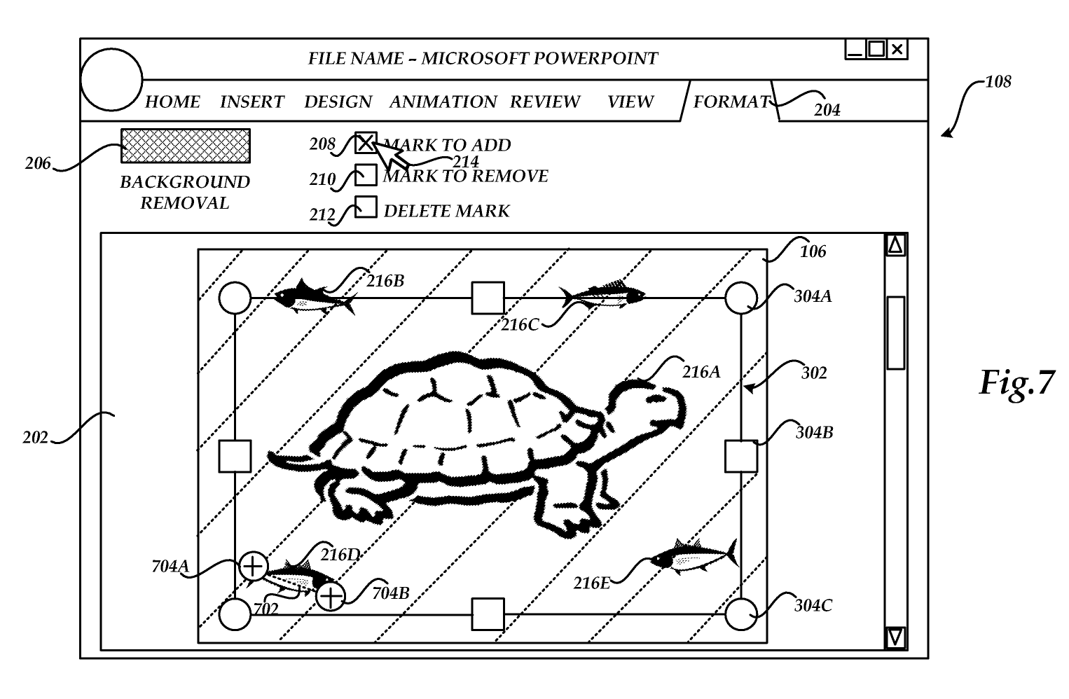

Referring now to FIG. 7, aspects of the user interface 108 for adding background portions of the image 106 to the foreground 114 will be described. As shown in FIG. 7, while in the background removal mode of operation, the user interface control 208 may be selected to specify portions of the image 106 to be included in the foreground 114. For instance, in one embodiment, a line segment 702 may be drawn on the image 106 to specify a portion of the image 106 to be included in the foreground 114. The indicators 704A-704B may be displayed at the ends of the line segment 704 to indicate that the corresponding portion of the image 106 will be added to the image 114. Any number of portions of the image 106 may be specified in this manner to add the corresponding portions to the foreground 114.

According to one embodiment, if the line segment 702 is outside the boundaries of the marquee 302, then the boundary of the marquee 302 will be enlarged such that the line segment 702 is inside the marquee 302. In this manner, the marquee 302 is modified to encompass the portion of the image 106 in the foreground 114.

In response to receiving a selection of the image 106 that to be included in the foreground 114, the presentation application 102 is configured to provide this information to the foreground extraction engine 110. Upon receiving this information, the foreground extraction engine 110 includes the corresponding portion of the image 106 within the foreground 114. As discussed above with respect to FIGS. 5-6, the foreground extraction engine 110 operates heuristically and, therefore, the line segment 702 need not be drawn completely over the portion of the image 106 to be included in the foreground 114. It should also be appreciated that, in one embodiment, if a very small line segment 702 is drawn, the size of the line segment 702 may be increased to provide a sufficiently long line segment to the foreground extraction engine 110.

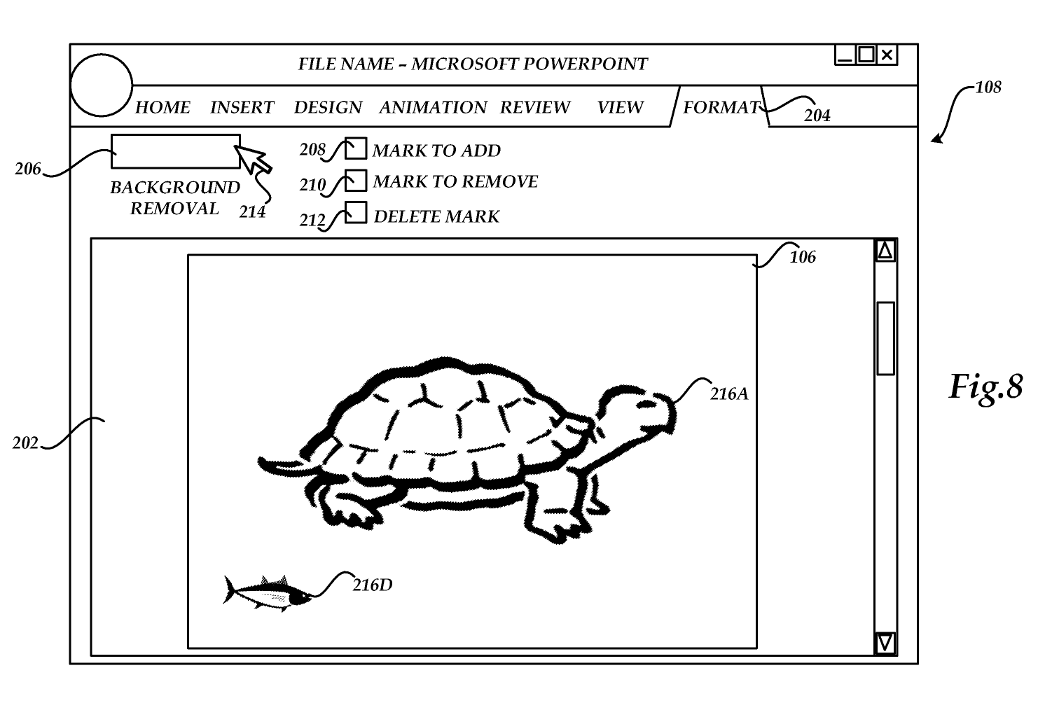

In the example shown in FIG. 7, a user has utilized cursor 214 to draw the line segment 702 over the object 216D. In this manner, the user has specified that the object 216D is to be included in the foreground 114 of the image 106. As a result, when the user interface control 206 is selected to exit the background removal mode of operation, the user interface 108 shown in FIG. 8 will be displayed. As illustrated in FIG. 8, the object 216D has been included in the foreground of the image 106 along with the object 216A. It should be appreciated that any number of portions of the background of the image 106 may be specified in this manner for inclusion in the foreground 114. As also described above, it should be appreciated that a line segment is merely illustrative, and that other shapes may be drawn over the image 106 to specify that corresponding portions of the image 106 be included in the foreground 114.

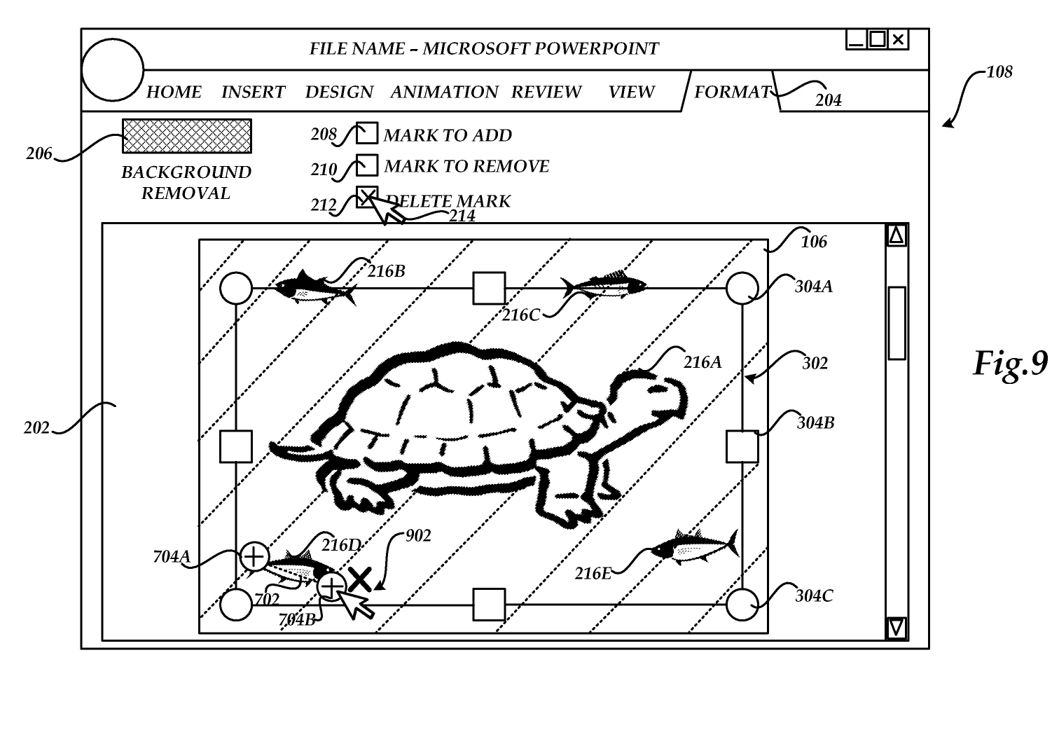

Referring now to FIG. 9, aspects of the user interface 108 for removing the line segments 502 and 702 will be described. In particular, by removing the line segments 502 and 702, portions of the image 106 that have been specified for inclusion in or removal from the foreground 114 can be removed. For instance, in the example shown in FIG. 9, the cursor 214 has been utilized to the select the user interface control 212. In response thereto, a selection tool 902 is provided through which a user may select the visual indicators 704A-704B or the line segment 702. Upon receiving such a selection, the line segment 702 and the indicator 704A-704B are removed. By removing the line segment 702, the corresponding portion of the image 106 that was specified for inclusion in the foreground 114 is returned to the background. It should be appreciated that the line segment 502 may be deleted in a similar manner thereby causing portions of the image 106 specified for inclusion in the background to be returned to the foreground.

It should be appreciated that, according to one embodiment, a modeless user interface may be provided for specifying portions of the image 106 to be included in the foreground 114, removed from the foreground 114, and for undoing such selections. In particular, in this embodiment, portions of the image 106 that are in the background may be marked with the cursor 214 for inclusion in the foreground 114. Portions of the image 106 in the foreground 114 may be marked using the cursor 214 for inclusion in the background. Portions of the image 106 previously marked for inclusion in the foreground 114 or for removal from the foreground 114 may be marked for deletion. In this manner, a user interface can be provided for performing these functions without the use of the user interface controls 208, 210, 212 and a separate mode of operation corresponding to each.

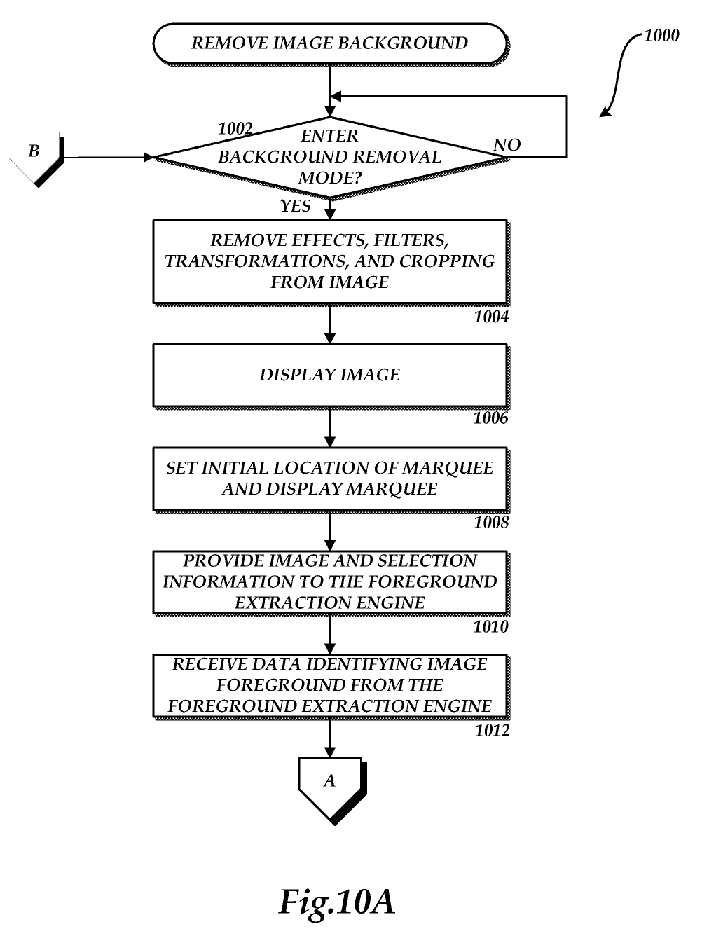

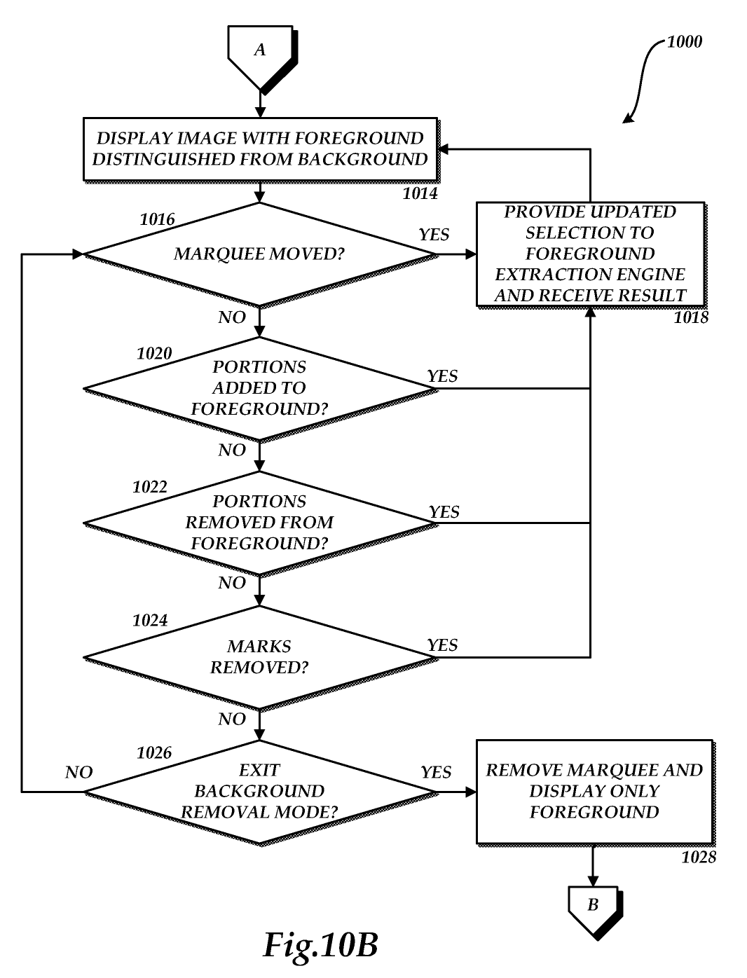

Referring now to FIGS. 10A-10B, additional details will be provided regarding the embodiments presented herein for image background removal. In particular, FIGS. 110-10B are flow diagrams illustrating aspects of the operation of the presentation application 102 in one embodiment for removing the background of an image 106 contained in a presentation document 104.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 1000 begins at operation 1002, where the presentation application 102 determines whether the image 106 has been selected and whether a request to enter the background removal mode of operation has been received. As discussed above, selection of the user interface control 206 comprises such a request in one embodiment. If no request to enter the background removal mode operation has been received, the routine 1000 returns to operation 1002 where another such determination is made. If, however, a request has been received to enter the background removal mode of operation, then the routine 1000 proceeds from operation 1002 to operation 1004.

At operation 1004, the presentation application 102 removes any effects, filters, transformations, and crops from the image 106, thereby leaving a two dimensional image suitable for foreground extraction. Once the effects have been removed from the image 106, the routine 1000 proceeds to operation 1006 where the image 106 is displayed. The routine 1000 then proceeds to operation 1008 where the initial location of the marquee 302 is set and where the marquee is displayed on top of the image 106. As discussed above, the initial location of the marquee 302 in one embodiment comprises a location inset from the four sides of the image 106.

From operation 1008, the routine 1000 proceeds to operation 1010 where the image 106 and the selection information 112 identifying the bounds of the marquee 302 are provided to the foreground extraction engine 110. As discussed above, the foreground extraction engine 110 takes this information and identifies the foreground within the image 106.

The presentation application 102 receives the foreground from the foreground extraction engine 110 at operation 1012. The routine 1000 then proceeds to operation 1014 where the presentation application 102 displays the image 106 with the foreground 114 distinguished from the background in the manner described above. Once the image 106 has been displayed, the routine 1000 then proceeds to operation 1016 where the presentation application 102 determines whether the marquee 302 has been moved or resized. If the marquee 302 has been moved or resized, the updated selection made by the marquee 302 is provided to the foreground extraction engine 110. An updated foreground 114 is then received by the presentation application 102. This occurs at operation 1018. From operation 1018, the routine 1000 returns to operation 1014 where the image is again displayed by the presentation application 102 with the foreground 114 distinguished from the remainder of the image 106.

If, at operation 1016, the presentation application 102 determines that the marquee 302 has not been moved or resized, the routine 1000 proceeds from operation 1016 to operation 1020. At operation 1020, the presentation application 102 determines whether portions of the image 106 have been added to the foreground 114 utilizing the user interface described above with respect to FIGS. 7-8. If portions of the image 106 have been added to the foreground 114, the routine 1000 proceeds to operation 1018 where the foreground 114 is updated and displayed.

If, at operation 1020, the presentation application 102 determines that portions of the image 106 have not been added to the foreground 114, the routine 1000 proceeds to operation 1022. At operation 1022, the presentation application 102 determines whether portions of the image 106 have been removed from the foreground 114 in the manner described above with reference to FIGS. 5-6. If so, the routine 1000 proceeds to operation 1018 where the foreground 114 is updated and displayed in the manner described above. If portions of the image 106 have not been removed from the foreground 114, the routine 1000 proceeds from operation 1022 to operation 1024.

At operation 1024, the presentation application 102 determines whether the line segments 502 and 702 have been removed from the image 106 in the manner described above. If so, the routine 1000 proceeds to operation 1018, where an updated foreground is received from the foreground extraction engine 110 and wherein the display of the image 106 is updated.

If, at operation 1024, the presentation application 102 determines that no line segments 502 or 702 have been removed, the routine 1000 proceeds to operation 1026. At operation 1026 the presentation application 102 determines whether a request has been received to exit the background removal mode operation, such as the selection of the user interface control 206. If not, the routine 1000 returns to operation 1016, described above. If a request has been received to exit the background removal mode of operation, the routine 1000 proceeds from operation 1026 to operation 1028 where the marquee 302 is removed from the display. The display of the line segments 502 and 702 and the portions of the image 106 selected for removal from the foreground are also removed from the display. Additionally as described above, only the portions of the image 106 identified as being in the foreground 114 are displayed following exit of the background removal mode of operation. From operation 1028, the routine 1000 proceeds to operation 1002 described above, where a user is permitted to once again enter the background removal mode of operation to fine tune the portions of the image 106 to be included or excluded from the foreground 114.

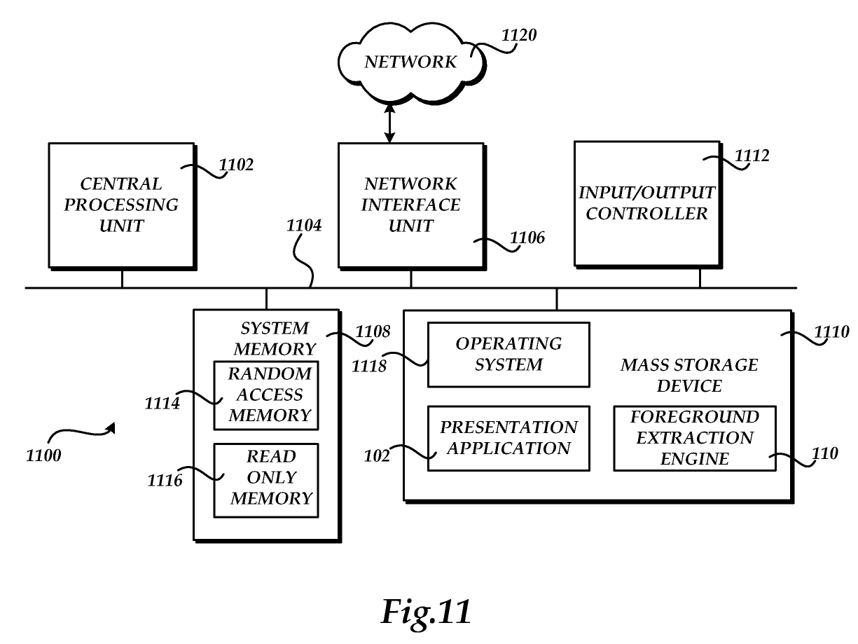

FIG. 11 shows an illustrative computer architecture for a computer 1100 capable of executing the software components described herein for image background removal in the manner presented above. The computer architecture shown in FIG. 11 illustrates a conventional desktop, laptop, or server computer and may be utilized to execute any of the software components presented herein, including the presentation application 102 or another application program configured to provide the user interface 108 for background removal and the foreground extraction engine 110.

The computer architecture shown in FIG. 11 includes a central processing unit 1102 (“CPU”), a system memory 1108, including a random access memory 1114 (“RAM”) and a read-only memory (“ROM”) 1116, and a system bus 1104 that couples the memory to the CPU 1102. A basic input/output system containing the basic routines that help to transfer information between elements within the computer 1100, such as during startup, is stored in the ROM 1116. The computer 1100 further includes a mass storage device 1110 for storing an operating system 1118, application programs, and other program modules, which are described in greater detail herein.

The mass storage device 1110 is connected to the CPU 1102 through a mass storage controller (not shown) connected to the bus 1104. The mass storage device 1110 and its associated computer-readable media provide non-volatile storage for the computer 1100. Although the description of computer-readable media contained herein refers to a mass storage device, such as a hard disk or CD-ROM drive, it should be appreciated by those skilled in the art that computer-readable media can be any available computer storage media that can be accessed by the computer 1100.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 1100.

According to various embodiments, the computer 1100 may operate in a networked environment using logical connections to remote computers through a network such as the network 1120. The computer 1100 may connect to the network 1120 through a network interface unit 1106 connected to the bus 1104. It should be appreciated that the network interface unit 1106 may also be utilized to connect to other types of networks and remote computer systems. The computer 1100 may also include an input/output controller 1112 for receiving and processing input from a number of other devices, including a keyboard, mouse, or electronic stylus (not shown in FIG. 11). Similarly, an input/output controller may provide output to a display screen, a printer, or other type of output device (also not shown in FIG. 11).

As mentioned briefly above, a number of program modules and data files may be stored in the mass storage device 1110 and RAM 1114 of the computer 1100, including an operating system 1118 suitable for controlling the operation of a networked desktop, laptop, or server computer. The mass storage device 1110 and RAM 1114 may also store one or more program modules. In particular, the mass storage device 1110 and the RAM 1114 may store the presentation application 102 and the foreground extraction engine 110, each of which was described in detail above with respect to FIGS. 1-10B. The mass storage device 1110 and the RAM 1114 may also store other types of program modules and data.

It should be appreciated that, in other embodiments, the user interface 108 provided herein might also be utilized in conjunction with a video file. For instance, in one embodiment the user interface 108 may be utilized to remove the background from a video file. In another embodiment, the user interface 108 might be utilized to specify a portion of a video file to be cropped. For instance, a user might utilize the user interface 108 to specify the portion of the first frame of a video to be cropped using the user interface 108. Subsequent frames of the video would be cropped in the specified manner.

According to yet other embodiments, user interface controls might also be provided for removing the foreground of an image to leave only the background. In another embodiment, a bulk edit mode of operation may be provided wherein modifications to the portion of the image 106 to be provided to the foreground extraction engine 110 may be queued and provided to the foreground extraction engine 110 in bulk. For instance, a particular keyboard key may be reserved for triggering this functionality. While the key is pressed, no selections will be provided to the foreground extraction engine 110. When the key is released, all of the selections made while the key was pressed will be provided to the foreground extraction engine 110.

In another implementation, a gallery of background removal options is provided. In this embodiment, the image 106 is analyzed and an attempt is made to select points of interest within the image 106. The identified areas of interest are then utilized to populate a gallery with background removal applied to thumbnails with marquees displayed around the points of interest. In this manner, a user may be presented with multiple possibilities for background removal. The user may then select one of the thumbnails to have the corresponding selection applied to the image 106.

Based on the foregoing, it should be appreciated that technologies for image background removal are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer storage medium having computer executable instructions stored thereon which, when executed by a computer, cause the computer to:
receive a request to enter a background removal mode of operation within which a user interface is provided for removing a background of an image, the user interface comprising a marquee for specifying a portion of the image to be provided to a foreground extraction engine; and
in response to receiving the request, to select a portion of the image using the marquee, to provide the portion of the image defined by the marquee to the foreground extraction engine, to receive a foreground of the image from the foreground extraction engine, to display the image such that the foreground is distinguished from the background of the image, and to display the marquee over the image.

2. The computer storage medium of claim 1, having further computer executable instructions stored therein which, when executed by the computer, cause the computer to receive a request to exit the background removal mode of operation and, in response thereto, to remove a display of the background and to remove the display of the marquee.

3. The computer storage medium of claim 2, wherein the image has four sides and wherein the marquee is a rectangle initially located at a position inset from the four sides of the image.

4. The computer storage medium of claim 3, having further computer executable instructions stored therein which, when executed by the computer, cause the computer to:
receive a request while in the background removal mode of operation to add a specified portion of the image to the foreground; and
in response to receiving the request to add the portion of the image to the foreground, to instruct the foreground extraction engine to include the specified portion of the image in the foreground.

5. The computer storage medium of claim 4, having further computer executable instructions stored therein which, when executed by the computer, cause the computer to:
determine while in the background removal mode of operation that the specified portion is outside of the marquee; and
in response to determining that the specified portion is outside of the marquee, to enlarge the marquee such that the specified portion is inside the marquee.

6. The computer storage medium of claim 5, having further computer executable instructions stored therein which, when executed by the computer, cause the computer to:
receive a request while in the background removal mode of operation to remove a specified portion of the image from the foreground; and
in response to receiving the request to remove the specified portion of the image from the foreground, to instruct the foreground extraction engine to remove the specified portion of the image from the foreground.

7. The computer storage medium of claim 6, having further computer executable instructions stored therein which, when executed by the computer, cause the computer to:
receive a request while in the background removal mode of operation to return the specified portion of the image to the foreground; and
in response to receiving the request to return the specified portion of the image to the foreground, to instruct the foreground extraction engine to return the specified portion of the image to the foreground.

8. A computer-implemented method for image background removal, the method comprising executing instructions on a computer for:
receiving a request to enter a background removal mode of operation for removing a background from an image; and
in response to the receiving the request, selecting a portion of the image using a marquee, providing the portion of the image defined by the marquee to a foreground extraction engine, receiving a foreground of the image from the foreground extraction engine, displaying the marquee, and transforming the image for display on a display screen with the foreground distinguished from the remainder of the image.

9. The computer-implemented method of claim 8, further comprising:
receiving a request to add a specified portion of the image to the foreground; and
in response to receiving the request to add the specified portion of the image to the foreground, instructing the foreground extraction engine to include the specified portion of the image to the foreground.

10. The computer-implemented method of claim 9, further comprising:
determining that the specified portion is outside the marquee; and
in response to determining that the specified portion is outside the marquee, enlarging the marquee so that the specified portion is inside the marquee.

11. The computer-implemented method of claim 9, further comprising:
receiving a request to return the specified portion to the background; and
in response to receiving the request to return the specified portion to the background, instructing the foreground extraction engine to remove the specified portion from the foreground.

12. The computer-implemented method of claim 8, further comprising:
receiving a request to remove a specified portion of the image from the foreground; and
in response to receiving the request to remove the portion of the image from the foreground, instructing the foreground extraction engine to remove the specified portion from the foreground.

13. The computer-implemented method of claim 12, further comprising:
receiving a request to return the specified portion to the foreground; and
in response to receiving the request to return the specified portion of the image to the foreground, instructing the foreground extraction engine to return the specified portion to the foreground.

14. The computer-implemented method of claim 8, wherein the image has four sides and wherein the marquee is a rectangle initially located at a position inset from the four sides of the image, and wherein the specified portion is defined by one or more line segments.

15. The computer-implemented method of claim 8, further comprising:
receiving a request to exit the background removal mode of operation; and
removing the display of the marquee and the background in response to receiving the request to exit the background removal mode of operation.

16. A computer storage medium having computer executable instructions stored thereon which, when executed by a computer, cause the computer to:
store a document having an image contained therein;
execute an application program configured to open the document and to display the image, the application program further configured to provide a background removal mode of operation in which a user interface is provided for removing the background of the image;
display a marquee while in the background removal mode of operation, the marquee initially positioned within four sides of the image and comprising a rectangle for defining a portion of the image to be provided to a foreground extraction engine; and to
receive a modification to the marquee and, in response to receiving the modification to the marquee, to provide a portion of the image defined by the marquee to the foreground extraction engine, to receive a foreground of the image from the foreground extraction engine, and to display the image such that the foreground identified by the foreground extraction engine is distinguished from the background of the image.

17. The computer storage medium of claim 16, wherein the application program comprises a presentation application and wherein the document comprises a presentation document.

18. The computer storage medium of claim 17, having further computer executable instructions stored therein which, when executed by the computer, cause the application program to remove one or more effects, filters, or transformations from the image prior to displaying the image and entering the background removal mode of operation.

19. The computer storage medium of claim 18, having further computer executable instructions stored therein which, when executed by the computer, cause the computer to:
receive a request while in the background removal mode of operation to add a portion of the image to the foreground, the portion of the image to be added to the foreground being defined by a line segment; and
in response to receiving the request to add the portion of the image to the foreground, to instruct the foreground extraction engine to include the portion of the image defined by the line segment in the foreground.

20. The computer storage medium of claim 19, having further computer executable instructions stored therein which, when executed by the computer, cause the computer to:
receive a request while in the background removal mode of operation to remove a portion of the image from the foreground, the portion of the image to be removed from the foreground being defined by a second line segment; and
in response to receiving the request to remove the portion of the image from the foreground, to instruct the foreground extraction engine to remove the portion of the image defined by the second line segment from the foreground.
